(19) United States
(12) Patent Application Publication
(10) Pub. No.: US 2017/0022404 A1
(43) Pub. Date: Jan. 26, 2017

(54) METHOD OF ICE FORMATION INHIBITION FOR WATERFOWL DECOY APPLICATION

(71) Applicant: OUTDOOR SPORTS PRODUCTS, LLC, GREENACRES, WA (US)

(72) Inventor: Brett Michael Clark, Spokane Valley, WA (US)

(73) Assignee: OUTDOOR SPORTS PRODUCTS LLC, GREENACRES, WA (US)

(21) Appl. No.: 14/809,096

(22) Filed: Jul. 24, 2015

(51) Int. Cl. C09K 3/18; A01M 99/00; A01M 31/06

(52) U.S. Cl. CPC C09K 3/185; A01M 31/06; A01M 99/00

(57) ABSTRACT

A method for maintaining hunting decoy appearance realism in the presence of ice formation on decoy surfaces, comprising a coating having a chemical composition that, upon application to a hunting decoy surface, inhibits ice formation or accumulation on the decoy surface by reducing the freezing point temperature on the decoy surface to below the ambient temperature. The coating composition may be adjusted to change the freezing point depending on the ambient temperature. The coating is a mixture of propylene glycol and polyethylene glycol in water, the propylene glycol component representing 10-90 volume %, the polyethylene component representing 0-5 volume %, with the balance water. In the presence of the coating, water changes from solid to liquid phase, and remains in the liquid phase in the coating mixture until it is removed through evaporation. The coating removes the optical reflectivity created by ice on the decoy surface by reducing the freezing point temperature of the surface to below that of water for the temperature conditions under which the decoys are used in hunting applications.

### FIELD OF THE INVENTION

The present invention relates to the use of decoys in hunting applications and, more particularly, to applying a coating to the decoy surface to maintain a realistic appearance.

### BACKGROUND OF THE INVENTION

The use of decoys is well established and critical to success in waterfowl hunting. The degree to which the decoy mimics the actual waterfowl species may constitute a limiting factor in the hunting success, particularly in locations where waterfowl are subject to frequent hunting. Elaborately detailed decoys have been produced to address this limitation and improve hunter success. In many hunting circumstances or situations, the ambient weather conditions are conducive to the formation of frost or ice on the decoy surfaces. The presence of frost or ice on the decoy surface reduces the realism of the decoy, particularly in clear weather conditions where ambient light reflects off the ice and gives the decoys an unnatural appearance. In such conditions, approaching waterfowl are more likely to detect the artificial nature of the decoys, and turn away rather than completing the approach to the decoys, a reaction known in waterfowl hunting as “flaring”. The problem is therefore increased optical reflectivity from the formation or deposition of ice on the decoy surface and the resulting degradation in decoy realism. The invention solves the problem by reducing the reflectivity from ice to water reflectivity.

A number of deicing compositions are described in the prior art, with emphasis on ice formation inhibition on aircraft (metal) surfaces or windshield (glass) surfaces.

Some representative prior art references:

Aircraft:

U.S. Pat. No. 6,391,224B1 Polyvinyl alcohol compounds for inhibition of ice growth

U.S. Pat. No. 7,927,505B2 Glycerin-containing antifreezing agent concentrates with corrosion protection

U.S. Pat. No. 4,954,279A Aircraft de-icing and anti-icing composition

U.S. Pat. No. 4,358,389A Agent for de-icing and protectiong against icing up

Windshield:

U.S. Pat. No. 3,096,290 Deicer composition

The prior art references utilize compositions containing a mixture of organic compounds and/or salts of organic compounds for the treatment of metal and glass surfaces. The treatment surfaces are assumed to be inert to chemical reactions with the applied compositions, and there is no consideration regarding the reaction of the applied composition with the metal or glass surface and subsequent degradation of the metal or glass surface. However, these compositions may be unsuitable when applied to a decoy surface containing polymeric plastics, organic adhesives, paints, or flocking materials, resulting in the degradation or change in the appearance or color of the decoy. In addition, the prior art compositions may present some degree of chemical reactivity, health, or toxicity risk. Furthermore, the prior art compositions may evaporate in such a time frame as to be of limited usefulness in hunting situations.

Additionally, the objective of prior art is to initiate the phase transition from solid water (ice) to liquid water to achieve the benefit of removing the water from the described surfaces, preferably within a time frame as short as possible. This invention contemplates effecting the phase transition from solid to liquid water, but retaining the water in the liquid state on the coated surface until it is removed gradually through evaporation.

It would be advantageous to provide a method for reducing optical reflectivity from a decoy surface arising from the presence of ice on the decoy surface.

It would also be advantageous to provide a coating composition that inhibits frost or ice formation or accumulation on a hunting decoy surface.

It would also be advantageous to provide a coating composition that may be applied by spraying on to a decoy surface.

It would be additionally advantageous to provide a coating composition that is non-toxic, non-hazardous, and has a low vapor pressure at or near atmospheric pressure and ambient temperature.

It would be additionally advantageous to provide a coating composition that does not degrade or change the decoy surface appearance or color, including paint, adhesives, or flocking.

It would be further advantageous to provide a coating composition which remains imbedded or on the decoy surface to impart the coating benefits to the surface for extended periods of time.

### SUMMARY OF THE INVENTION

In accordance with the present invention, there is provided a method of maintaining hunting decoy appearance in the presence of ice accumulation by using a coating having a chemical composition that, upon application to a hunting decoy surface, inhibits ice formation or accumulation on the decoy surface by reducing the freezing point temperature on the decoy surface to below the ambient temperature. The coating has a freezing point lower than that of water at or near atmospheric pressure. The coating is a mixture of propylene glycol and polyethylene glycol in water, the propylene glycol component representing 10-90 volume %, the polyethylene component representing 0-5 volume %, with the balance water. In the presence of the coating, water changes from solid to liquid phase, and remains in the liquid phase in the coating mixture until it is removed gradually through evaporation.

### BRIEF DESCRIPTION OF THE DRAWINGS

A complete understanding of the present invention may be obtained by reference to the accompanying drawings, when considered in conjunction with the subsequent, detailed description, in which:

FIG. 1 is the water/propylene glycol binary phase diagram;

FIG. 2 is the phase diagram describing the coating composition for ice formation conditions for temperatures above −7 degrees celsius;

FIG. 3 is the phase diagram describing the coating composition for ice formation conditions for temperatures above −60 degrees celsius;

FIG. 4 is the phase diagram describing the coating freezing point depression through water evaporation; and

FIG. 5 is the phase diagram describing the coating composition for increased volume ice conditions.

For purposes of clarity and brevity, like elements and components will bear the same designations and numbering throughout the Figures.

### DESCRIPTION OF THE PREFERRED EMBODIMENT

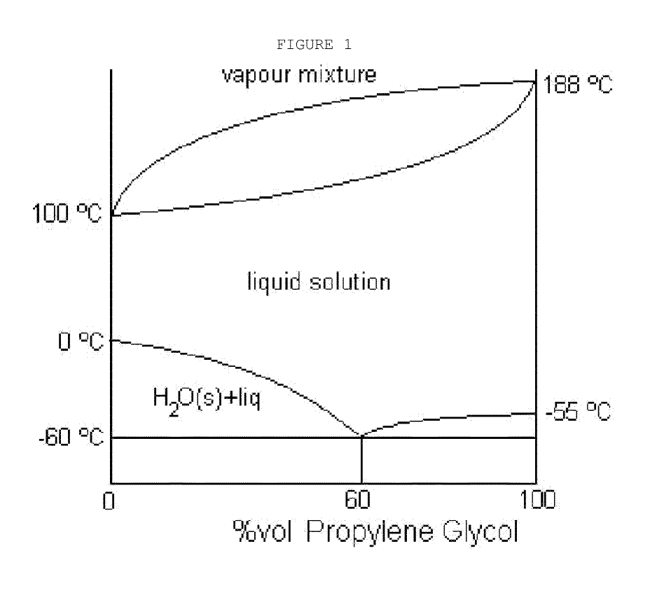

The freezing point of pure water (for example, zero volume % propylene glycol in FIG. 1) is known to be 0 degrees celsius. Therefore, any temperature less than 0 degrees celsius and typical ambient pressure will result in ice deposition on the decoy surface at sufficient relative humidity. The freezing point of water in solution is depressed by addition of one or more compounds with freezing points less than that of water and with which water is miscible. It is therefore desirable to add a coating comprising one or more compounds with freezing points less than water to the decoy surface. FIG. 1 is the water/propylene glycol binary phase diagram. This diagram shows that the freezing point of the coating decreases as amount of propylene glycol relative to water in the coating increases to 60%. At compositions greater than 60% propylene glycol, the freezing point of the coating increases slightly. It is also desirable that the coating composition be substantially chemically inert with respect to the decoy surface, such that the decoy color, appearance, or flocking are unchanged after frequent and prolonged applications of the coating. It is advantageous that the coating be non-toxic, non-hazardous. It is further advantageous that the coating have very low vapor pressure at typical ambient pressure and temperature from 0 to 50 degrees celsius. In accordance with these criteria, a coating composition containing propylene glycol (such as, for example Durvet™ part #7-45801-11187-7), polyethylene glycol 400 (such as, for example Sigma-Aldrich™ part #202398), and water is acceptable. In one embodiment, the non-water components may be raw or technical grade. In another embodiment, the non-water components may be food grade or pharmacopoeia grade. The components are mixed together at room temperature in a suitable container to form the desired coating composition. While the invention is described with reference to propylene glycol and water, it is to be understood that the addition of the polyethylene glycol component has the purpose and effect of further lowering the freezing point of the coating composition, as well as further reducing the vapor pressure of the coating composition. The composition is described with respect to polyethylene glycol 400, but any higher average molecular weight water soluble polyethylene glycol is suitable for use in the composition.

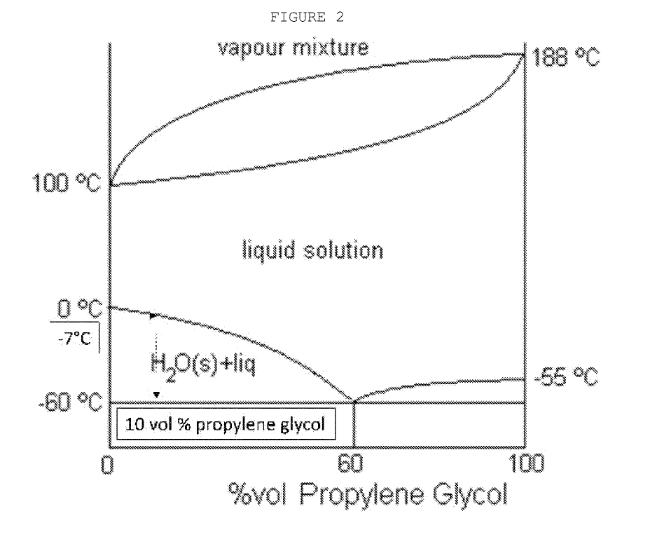

In one embodiment shown in FIG. 2, temperature conditions above −7 degrees celsius require a coating composition with 10 volume % propylene glycol and 0.1-5 volume % polyethylene glycol to achieve acceptable freezing point depression on the decoy surface.

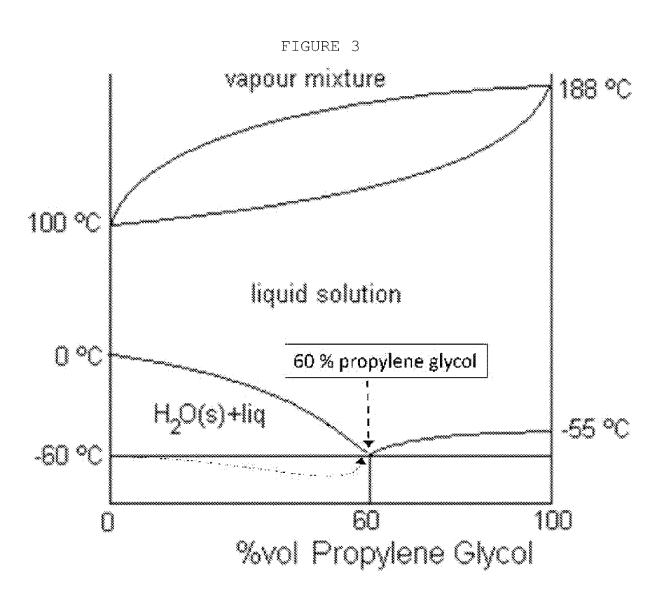

In another embodiment shown in FIG. 3, temperature conditions −60 degrees celsius require a coating composition with 60 volume % propylene glycol and 0.1-5% volume % polyethylene glycol to achieve acceptable freezing point depression on the decoy surface. Moreover, it is to be understood that the suitable coating composition to depress the freezing point to any given temperature within the range of 0 degrees celsius to −60 degrees celsius may be determined from FIG. 1.

The coating may be applied by spraying the coating on to the surface to be treated. Alternatively, the decoy surface may be immersed in the coating for a time suitable to achieve adsorption of the coating on to or into the surface. The process and method for coating application follows those practiced by those of ordinary skill in the art. The coating application may occur prior to the use of decoys in typical hunting conditions, during decoy use in typical hunting conditions, or after decoy use in typical hunting conditions. In some embodiments, repeated coating applications may be advantageous.

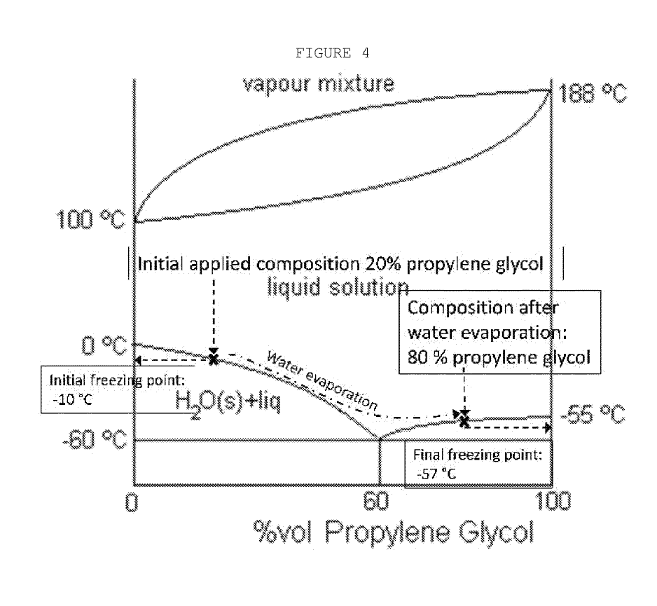

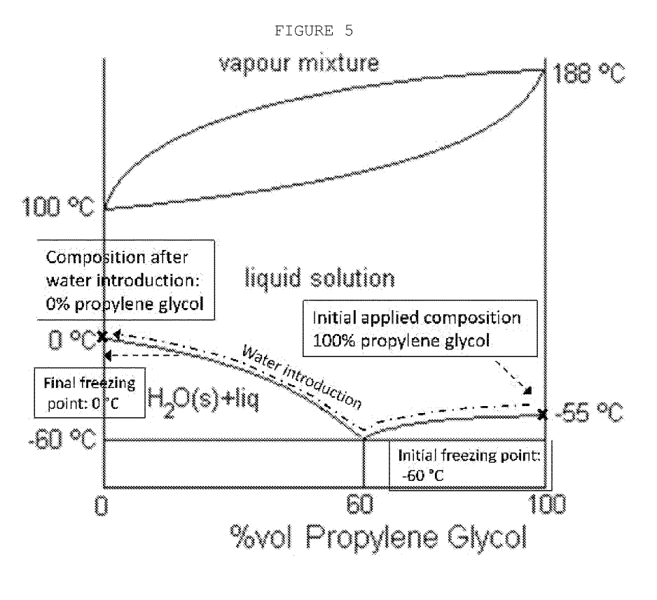

In another embodiment, the coating is applied on the decoy surface prior to decoy usage in conditions where ice exposure occurs, the coating containing up to 95 volume % water. The water component of the coating preferentially evaporated relative to the lower vapor pressure components in the coating, and the lower volatility components remain on the decoy surface. The evaporation process may occur at ambient temperature and pressure, or, alternatively, may be performed at temperatures above ambient and/or pressures below ambient to accelerate the evaporation process relative to ambient. Upon removing some or all of the water component, the resultant composition increases in relative concentration of propylene glycol and polyethylene glycol as shown in FIG. 4. The increase in relative concentration of propylene glycol and polyethylene glycol results in the freezing point decreasing to as low as −60 degrees celsius. The example in FIG. 5 shows an initial coating composition of 80 volume % water and 20 volume % propylene glycol, which has a freezing point of −10 degrees celsius. The water component evaporates until the coating composition is 20 volume % water and 80 volume % propylene glycol, with a corresponding freezing point of −57 degrees celsius. Therefore, evaporation of water has reduced the freezing point of the coating from −7 degrees celsius to −57 degrees celsius. It is therefore advantageous in some embodiments to apply the coating prior to use with the understanding that the freezing point depression performance of the coating will improve in the described manner.

Conversely, reducing the relative concentration of propylene glycol and polyethylene glycol by introducing water to the surface will result in the freezing point temperature rising. The introduction of water to the surface may include, but is not limited to, rain, snow, sleet, or any combination thereof. The example shown in FIG. 5 describes an initial coating composition of 100% propylene glycol with a freezing point depression of −55 degrees celsius. Dilution of the coating composition to 60% propylene glycol decreases the freezing point down to −60 degrees celsius. Additional introduction of water thereafter increases the freezing point temperature until the coating is substantially comprised of water and have a freezing point of 0 degrees celsius. If the volume of water introduced is sufficient to wash the coating form the decoy surface, reapplication or continued application on the coating is necessary to achieve a suitable freezing point temperature on the decoy surface.

In the case of snow introduction to the decoy surface, it is advantageous to utilize a coating composition with a relative water concentration less than 5 volume %, or less than 1 volume %. To state another way, in the case of heavy frost or snow exposure to the decoy surface it is advantageous to saturate the surface with a composition 95-99.9 volume % propylene glycol and 0.1-5 volume % polyethylene glycol. The coating capacity to absorb and convert ice to water increases with decreasing relative volume % of water, and increases with the absolute concentration of propylene glycol and polyethylene glycol on the decoy surface. Considering this, a decoy surface which absorbs propylene glycol and polyethylene glycol has an increased capacity to convert ice to water relative to a decoy surface with diminished absorbing capacity. An example of a decoy surface with coating absorption characteristics is a flocked decoy, such as, for example, an Avian X AXF™ fully flocked decoy. An example of a decoy surface with diminished absorption characteristics is a painted decoy, such as, for example, an Avery Green Head Gear Pro Grade™ decoy.

In another preferred embodiment, the presence of water in the coating may damage the decoy. An example of such a water sensitive decoy may include, but is not limited to, a taxidermist decoy. The coating in this embodiment is 100 volume % propylene glycol, 100 volume % polyethylene glycol, or any combination of the two.

While the disclosure has described a composition comprising propylene glycol and polyethylene glycol, any polyol or combination of polyol compounds suitable for freezing point depression on a decoy surface may be substituted.

### Example 1

A coating was made by combining 284 mL of water, 273 mL of propylene glycol (Durvet™ part #7-45801-11187-7), and 1.25 mL of polyethylene glycol 20,000 (Alpha Aesar™ stock # A17925) and stirring until all components were homogeneously mixed. Two Avery Green Head Gear FFD Elite Lesser Goose™ decoys were utilized in the test. One decoy was sprayed with the coating on the back, sides, and head, and the other decoy served as an untreated control. The decoys were exposed to the typical hunting environment for nine days after the coating application, during which the minimum temperature and relative humidity were recorded and the presence or absence of ice on the decoys was observed. The data and observation results are displayed in Table 1. Frost accumulation was observed on the uncoated decoy consistently when conditions resulted in frost events. The treated decoy exhibited no frost accumulation after initial coating treatment for three days. Rain events on days 4-6 resulted in coating dilution or removal as described previously in this disclosure, resulting in ice accumulation on day 7 on the treated decoy surface. The coating was reapplied to the previously treated decoy, which resulted in reproducing the initial frost inhibition observed on days 1-3 for days 8-9. On all 5 days where the coating was in place during frost formation conditions, the coated decoy consistently lacked frost whereas the uncoated decoy consistently exhibited frost on the surface.

TABLE 1
Condition data and frost observation results
for treated and untreated decoys.

| | Minimum | Minimum % | Frost on | Frost on |
|---|---|---|---|---|
| | Temperature | Relative | Coated | Uncoated |
| Day | (° C.) | Humidity | Decoy | Decoy |
| 1 | −18 | 45 | No | Yes |
| 2 | −6 | 38 | No | Yes |
| 3 | −5 | 50 | No | Yes |
| 4 | 1 | Rain | No | No |
| 5 | 1 | Rain | No | No |
| 6 | −2 | Rain | No | No |
| 7 | −5 | light snow | Yes | Yes |
| 8 | −13 | 31 | No | Yes |
| 9 | −14 | 34 | No | Yes |

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of ice formation inhibition for waterfowl decoy application for maintaining realistic decoy appearance by preventing or inhibiting ice accumulation on waterfowl decoy surfaces, comprising:
means for maintaining realistic decoy appearance by inhibiting ice formation on a decoy surface;
means for decoy surface ice melting for ambient temperatures from 0 to −7 degrees celsius, chemically conditioned to said means for maintaining realistic decoy appearance by inhibiting ice formation on a decoy surface;
means for decoy surface ice melting down to −60 degrees celsius, chemically conditioned to said means for maintaining realistic decoy appearance by inhibiting ice formation on a decoy surface;
means for decreasing coating freezing point depression through evaporation of water component, chemically conditioned to said means for maintaining realistic decoy appearance by inhibiting ice formation on a decoy surface;
means for maintaining decoy surface freezing point temperature during increased ice volume conditions, chemically conditioned to said means for maintaining realistic decoy appearance by inhibiting ice formation on a decoy surface; and
means for treatment for decoys which are degraded by coatings containing water, chemically conditioned to said means for maintaining realistic decoy appearance by inhibiting ice formation on a decoy surface.

2. The method of ice formation inhibition for waterfowl decoy application in accordance with claim 1, wherein said means for maintaining realistic decoy appearance by inhibiting ice formation on a decoy surface comprises a 10-90 vol % propylene glycol, 0.1-5 vol % polyethylene glycol, balance water method of maintaining decoy appearance by inhibiting ice formation.

3. The method of ice formation inhibition for waterfowl decoy application in accordance with claim 1, wherein said means for decoy surface ice melting for ambient temperatures from 0 to −7 degrees celsius comprises a 10 volume % propylene glycol, 0-5 volume % polyethylene glycol, 85-90 volume % water coating composition for ice formation conditions above −7 degrees celsius.

4. The method of ice formation inhibition for waterfowl decoy application in accordance with claim 1, wherein said means for decoy surface ice melting down to −60 degrees celsius comprises a 60 volume % propylene glycol, 0-5 volume % polyethylene glycol, 35-40 volume % water coating composition for ice formation conditions down to −60 degrees celsius.

5. The method of ice formation inhibition for waterfowl decoy application in accordance with claim 1, wherein said means for decreasing coating freezing point depression through evaporation of water component comprises a freezing point decreasing due to water evaporation from a coating to depress the freezing point of a composition.

6. The method of ice formation inhibition for waterfowl decoy application in accordance with claim 1, wherein said means for maintaining decoy surface freezing point temperature during increased ice volume conditions comprises a 80-100 volume % propylene glycol, 0-5 volume % polyethylene glycol, 0-20 volume % water coating composition for increased ice volume conditions.

7. The method of ice formation inhibition for waterfowl decoy application in accordance with claim 1, wherein said means for treatment for decoys which are degraded by coatings containing water comprises a 0% water, 100% polyethylene glycol polyethylene glycol treatment for taxidermy decoys.

8. A method of ice formation inhibition for waterfowl decoy application for maintaining realistic decoy appearance by preventing or inhibiting ice accumulation on waterfowl decoy surfaces, comprising:
a 10-90 volume % propylene glycol, 0.1-5 volume % polyethylene glycol, balance water method of maintaining decoy appearance by inhibiting ice formation, for maintaining realistic decoy appearance by inhibiting ice formation on a decoy surface;
a 10 volume % propylene glycol, 0-5 volume % polyethylene glycol, 85-90 volume % water coating composition for ice formation conditions above −7 degrees celsius, for decoy surface ice melting for ambient temperatures from 0 to −7 degrees celsius, chemically conditioned to said Method of maintaining decoy appearance by inhibiting ice formation;
a 60 volume % propylene glycol, 0-5 volume % polyethylene glycol, 35-40 volume % water coating composition for ice formation conditions down to −60 degrees celsius, for decoy surface ice melting down to −60 degrees celsius, chemically conditioned to said Method of maintaining decoy appearance by inhibiting ice formation;
a freezing point decreasing due to water evaporation coating freezing point depression enhancement through water evaporation, for decreasing coating freezing point depression through evaporation of water component, chemically conditioned to said Method of maintaining decoy appearance by inhibiting ice formation;
a 80-100 volume % propylene glycol, 0-5 volume % polyethylene glycol, 0-20 volume % water coating composition for increased ice volume conditions, for maintaining decoy surface freezing point temperature during increased ice volume conditions, chemically conditioned to said Method of maintaining decoy appearance by inhibiting ice formation; and
a 0% water, 100% polyethylene glycol polyethylene glycol treatment for taxidermy decoys, for treatment for decoys which are degraded by coatings containing water, chemically conditioned to said Method of maintaining decoy appearance by inhibiting ice formation.

9. A method of ice formation inhibition for waterfowl decoy application for maintaining realistic decoy appearance by preventing or inhibiting ice accumulation on waterfowl decoy surfaces, comprising:
a 10-90 volume % propylene glycol, 0.1-5 volume % polyethylene glycol, balance water method of maintaining decoy appearance by inhibiting ice formation, for maintaining realistic decoy appearance by inhibiting ice formation on a decoy surface;
a 10 volume % propylene glycol, 0-5 volume % polyethylene glycol, 85-90 volume % water coating composition for ice formation conditions above −7 degrees celsius, for decoy surface ice melting for ambient temperatures from 0 to −7 degrees celsius, chemically conditioned to said Method of maintaining decoy appearance by inhibiting ice formation;
a 60 volume % propylene glycol, 0-5 volume % polyethylene glycol, 35-40 volume % water coating composition for ice formation conditions down to −60 degrees celsius, for decoy surface ice melting down to −60 degrees celsius, chemically conditioned to said Method of maintaining decoy appearance by inhibiting ice formation;
a freezing point decreasing due to water evaporation coating freezing point depression enhancement through water evaporation, for decreasing coating freezing point depression through evaporation of water component, chemically conditioned to said Method of maintaining decoy appearance by inhibiting ice formation;
a 80-100 volume % propylene glycol, 0-5 volume % polyethylene glycol, 0-20 volume % water coating composition for increased ice volume conditions, for maintaining decoy surface freezing point temperature during increased ice volume conditions, chemically conditioned to said Method of maintaining decoy appearance by inhibiting ice formation; and
a 0% water, 100% polyethylene glycol polyethylene glycol treatment for taxidermy decoys, for treatment for decoys which are degraded by coatings containing water, chemically conditioned to said Method of maintaining decoy appearance by inhibiting ice formation.
